(19) United States
(12) Patent Application Publication
(10) Pub. No.: US 2012/0130562 A1
(43) Pub. Date: May 24, 2012

(54) DATA COMMUNICATION SYSTEM FOR A RAIL VEHICLE AND METHOD FOR COMMUNICATING DATA WITH A RAIL VEHICLE

(75) Inventors: John William Brand, Melbourne, FL (US); David Teeter, Melbourne, FL (US); Robert Foy, Melbourne, FL (US); Jared Cooper, Melbourne, FL (US); Frank Wawrzyniak, Melbourne, FL (US); Samuel Golden, Melbourne, FL (US)

(73) Assignee: General Electric Company, Schenectady, NY (US)

(21) Appl. No.: 13/105,323

(22) Filed: May 11, 2011

Related U.S. Application Data
(63) Continuation-in-part of application No. 13/046,808, filed on Mar. 14, 2011.
(60) Provisional application No. 61/415,385, filed on Nov. 19, 2010.

(51) Int. Cl. G05D 1/02; G06K 7/01; G06F 17/00

(52) U.S. Cl. 701/2; 701/19; 235/375; 340/10.42

(57) ABSTRACT

A data communication system for a rail vehicle includes a data reading device and a processing module. The data reading device is disposed on the rail vehicle and is configured to at least one of electromagnetically interrogate or optically read identification data that is visually presented on a first operator control unit. The first operator control unit is configured to remotely control operations of one or more powered units of a rail vehicle consist when the operator control unit is disposed outside of the one or more powered units. The processing module is disposed on the rail vehicle and is communicatively coupled with the data reading device. The processing module receives the identification data from the data reading device and uses the identification data to identify the first operator control unit and allow the first operator control unit to remotely control operations of the one or more powered units.

### CROSS-REFERENCE TO RELATED APPLICATIONS

The present application is a continuation-in-part of U.S. patent application Ser. No. 13/046,808, which was filed on 14Mar. 2011, and is entitled “Data Communication System For A Rail Vehicle Consist And Method For Communicating Data With A Rail Vehicle Consist” (the “'808 Application”), which also claims priority to U.S. Provisional Application No. 61/415,385, which was filed on 19Nov. 2010, and is entitled “Data Communication System For A Rail Vehicle Consist And Method For Communicating Data With A Rail Vehicle Consist” (the “'385 Application”). The present application also claims priority to the '385 Application. The entire disclosures of the '808 Application and the '385 Application (including the specification, claims, and drawings) are hereby incorporated by reference in their entirety.

### BACKGROUND

One or more embodiments of the subject matter described herein relate to data communications and, more particularly, to data communications with a rail vehicle.

Rail vehicles may include multiple powered units, such as locomotives, that are mechanically coupled or linked together in a consist. The consist of powered units operates to provide tractive and/or braking efforts to propel and stop movement of the rail vehicle. The powered units in the consist may change the supplied tractive and/or braking efforts based on information that is wirelessly transmitted to the consist, such as by a TCP/IP-based wireless network.

The information that is wirelessly transmitted to the consist may relate to the cargo that is carried by the consist, a route that the rail vehicle is to traverse during an upcoming trip, emissions limitations on the powered units, speed limits, and the like. The information may be used by a software application, such as Trip Optimizer™ from General Electric Company, to determine the speed of the rail vehicle for various segments of an upcoming trip of the rail vehicle. For example, the software application may use the information to form a trip profile that includes throttle and/or brake settings for various segments of the trip. The powered units may then propel the consist according to the trip profile.

The wireless transmission of the information is subject to several propagation problems. These problems include, but are not limited to, the existence of dead spots or low signal strength areas along the route that the rail vehicle travels, reduced transmission rates due to the need to re-transmit lost data, and the like. Additional problems associated with wireless transmission of data messages include atmospheric interference, mechanical failure of the receiving antenna module, and the like.

Some consists include powered units that can be remotely controlled by handheld or human-portable units carried by operators. For example, some consists include remote control locomotives (RCL) that can be controlled by handheld operator control units (OCU). An operator holding an OCU can wirelessly transmit commands to the RCL to change movements of the RCL, such as by changing tractive efforts and/or braking efforts of the RCL. The OCUs are initialized by linking the OCUs with the RCL or RCLs that are to be controlled by the OCU. Only OCUs that are linked with an RCL may control operations of the RCL. Some known OCUs are linked with an RCL using an infrared (IR) scanner. For example, an OCU may have an IR transmitter that transmits an IR signal to an IR receptor on the RCL. The IR signal links the OCU with the RCL such that the OCU can control operations of the RCL.

The addition of an IR receptor on the RCLs to receive the IR signals from the OCUs requires the addition of hardware to the RCLs. For example, if a powered unit does not include an IR receptor, then the powered unit cannot be linked with and controlled by OCUs having IR transmitters. An IR receptor must be added to the powered unit. Moreover, the IR transmitters on the OCUs can fail after time. The addition of IR receptors and the maintenance of IR transmitters of the OCUs can increase the cost and/or complexity of remotely controlling powered units of a consist.

A need exists for a system and method for communicating with a rail vehicle that avoids one or more of the above shortcomings

### BRIEF DESCRIPTION OF THE INVENTION

In one embodiment, a data communication system for a rail vehicle consist is provided. The system includes a data reading device and a processing module. As used herein, the term “module” includes a hardware and/or software system that operates to perform one or more functions. For example, a module may include a computer processor, controller, or other logic-based device that performs operations based on instructions stored on a tangible and non-transitory computer readable storage medium, such as a computer memory. Alternatively, a module may include a hard-wired device that performs operations based on hard-wired logic of the device. The modules shown in the attached figures may represent the hardware that operates based on software or hardwired instructions, the software that directs hardware to perform the operations, or a combination thereof.

The data reading device is disposed on the rail vehicle consist and is configured to at least one of electromagnetically interrogate or optically read identification data that is visually presented on a first operator control unit. The first operator control unit is configured to remotely control operations of one or more powered units of the rail vehicle consist when the operator control unit is disposed outside of the one or more powered units. The processing module is disposed on the rail vehicle consist and is communicatively coupled with the data reading device. The processing module receives the identification data from the data reading device and uses the identification data to identify the first operator control unit and allow the first operator control unit to remotely control operations of the one or more powered units.

In another embodiment, a method for communicating data with a rail vehicle consist is provided. The method includes, on a rail vehicle of the rail vehicle consist, at least one of interrogating or reading identification data that is visually presented on a first operator control unit using a data reading device. The first operator control unit is configured to remotely control operations of one or more powered units of the rail vehicle consist when the operator control unit is disposed outside of the one or more powered units. The method also includes identifying the first operator control unit as a linked operator control unit based on the identification data that is read from the first operator control unit and receiving control data from the linked operator control unit to change at least one operation of the one or more powered units.

In another embodiment, a computer readable storage medium is provided. The computer readable storage medium includes one or more sets of instructions that direct a data reading device on a powered unit of a rail vehicle consist to at least one of interrogate or optically read identification data that is visually presented on a first operator control unit. The first operator control unit is configured to remotely control operations of one or more powered units of the rail vehicle consist when the operator control unit is disposed outside of the one or more powered units. The one or more sets of instructions also direct a processor on board the consist to identify the first operator control unit based on the identification data, and receive control data transmitted from the first operator control unit that is used to control at least one operation of one or more of the powered units.

In another embodiment, a data communication system for a rail vehicle is provided. The system includes a human-portable operator control unit having an electronic display, an operator interface, a transceiver, and a control module. The display, the operator interface, and the transceiver are operably coupled to the control module. The operator interface is configured to receive operator input from a human operator. The control module is configured to generate control data based on the operator input. The transceiver is configured to transmit the control data to the rail vehicle for remotely controlling the rail vehicle. The control module is configured to control the display for visually presenting identification data of the operator control unit. The identification data is configured for at least one of electromagnetic interrogation or optical reading off of the display by a data reading device spaced apart from the operator control unit.

In another embodiment, a computer readable storage medium comprising one or more sets of instructions is provided. The computer readable storage medium includes one or more sets of instructions are readable by a control module of a human-portable operator control unit for remotely controlling a rail vehicle. The one or more sets of instructions are configured, when executed by the control module, to cause the control module to control a display of the operator control unit for visually presenting identification data of the operator control unit, the identification data being configured for at least one of electromagnetic interrogation or optical reading off the display by a data reading device spaced apart from the operator control unit.

In another embodiment, a data communication system for a rail vehicle is provided. The system includes a processing module configured to interface with a propulsion subsystem of a rail vehicle and with a data reading device configured to at least one of electromagnetically interrogate or optically read identification data that is visually presented on a first operator control unit. The processing module is configured to receive identification data from the data reading device and to use the identification data to identify the first operator control unit and allow the first operator control unit to remotely control operations of the rail vehicle.

In another embodiment, a data communication system for a rail vehicle is provided. The system includes a data reading device comprising a base for at least one of mechanically or electrically installing the data reading device on a rail vehicle. The data reading device also includes a reader unit attached to the base and configured to at least one of electromagnetically interrogate or optically read identification data that is visually presented on a first operator control unit. The system also includes a processing module configured to interface with the data reading device and with a control system of the rail vehicle, the processing module configured to receive identification data from the data reading device and to use the identification data to identify the first operator control unit and allow the first operator control unit to remotely control operations of the rail vehicle.

### BRIEF DESCRIPTION OF THE DRAWINGS

The present invention will be better understood from reading the following description of non-limiting embodiments, with reference to the attached drawings, wherein below:

FIG. 1 is a schematic diagram of one embodiment of a data communication system for a rail vehicle consist;

FIG. 2 is an illustration of one embodiment of the communication system that includes an optical scanner as the data reading device shown in FIG. 1;

FIG. 3 is an illustration of another embodiment of the communication system that includes an RFID interrogator device or reader as the data reading device shown in FIG. 1;

FIG. 4 is a schematic illustration of one embodiment of a data generation system and the communication system shown in FIG. 1;

FIG. 5 is a flowchart of one embodiment of a method for communicating data with a rail vehicle consist;

FIG. 6 is a schematic diagram of one embodiment of a data communication system for a rail vehicle consist;

FIG. 7 is another schematic diagram of the communication system shown in FIG. 6; and

FIG. 8 is a flowchart of another embodiment of a method for communicating data with a rail vehicle consist.

### DETAILED DESCRIPTION OF THE INVENTION

Reference will be made below in detail to embodiments of the inventive subject matter, examples of which are illustrated in the accompanying drawings. Wherever possible, the same reference numerals used throughout the drawings refer to the same or like parts. Although example embodiments of the inventive subject matter are described with respect to trains, locomotives, and other rail vehicles, embodiments also may be applicable for use with vehicles generally, such as off-highway vehicles, agricultural vehicles, and/or transportation vehicles, each of which may include a vehicle consist. A vehicle consist is a group of one or more powered units (such as locomotives) or other vehicles that are mechanically coupled or linked together to travel along a route, with each vehicle in the consist being adjacent to one or more other vehicles in the consist. A consist may include a single powered unit or multiple powered units. By way of example, a rail vehicle consist (e.g., train) may include several powered and non-powered units or cars (e.g., rail vehicles), with the powered units being capable of self-propulsion and the non-powered units being incapable of self-propulsion. A locomotive consist may include several powered units (e.g., locomotives) that coordinate the tractive and/or braking efforts provided by the powered units such that the locomotive consist operates as a single unit. The rail vehicle consist may include one or more locomotive consists.

At least one embodiment described herein provides for communication systems that communicate data with a vehicle by optically and/or electromagnetically scanning or reading the data. For example, the data may be encoded or recorded in an image, such as a printed bar code or an electronically presented bar code, or in a radio frequency identification (RFID) tag or label. The data can be provided on a tangible and non-transitory medium, such as a paper document, handheld (e.g., human-portable) electronic device having a display device (e.g., mobile phone or personal digital assistant), and the like. In one embodiment, the data is provided as a bar code that is printed on a train manifest document. A data reading device interrogates the medium that includes the data (e.g., transmits light beams or electromagnetic waves toward the medium having the printed image or RFID tag) in order to read the data from the medium.

The data can be optically and/or electromagnetically read from the tangible and non-transitory medium for use by the rail vehicle. The data may represent or include a variety of information. By way of example, the data may include trip data, train data, track data, and/or an update to trip data, train data, or track data. Train data includes information about the rail vehicle and/or cargo being carried by the rail vehicle. For example, train data may represent cargo content (such as information representative of cargo being transported by the rail vehicle) and/or rail vehicle information (such as model numbers, manufacturers, horsepower, and the like, of locomotives and/or other railcars in the rail vehicle). Trip data includes information about an upcoming trip by the rail vehicle. By way of example only, trip data may include a trip profile of an upcoming trip of the rail vehicle (such as information that can be used to control one or more operations of the rail vehicle, such as tractive and/or braking efforts provided during the powered units of a rail vehicle consist during an upcoming trip), station information (such as the location of a beginning station where the upcoming trip is to begin and/or the location of an ending station where the upcoming trip is to end), restriction information (such as work zone identifications, or information on locations where the track is being repaired or is near another track being repaired and corresponding speed/throttle limitations on the rail vehicle), and/or operating mode information (such as speed/throttle limitations on the rail vehicle in various locations, slow orders, and the like). Track data includes information about the track or rails upon which the rail vehicle travels. For example, the track data can include information about locations of damaged sections of a track, locations of track sections that are under repair or construction, the curvature and/or grade of a track, GPS coordinates of the track, and the like. The track data is related to operations of the rail vehicle as the track data includes information about the track that the rail vehicle is or will be traveling on. However, other types of data can be recorded as the data and/or the data may be used for other operations. The term “data” may refer to trip data, train data, and track data, only one of trip data, train data, or track data, or another type of data.

Alternatively, the data may be visually presented on an electronic device, such as a handheld or human portable operator control unit (OCU), that is used to remotely control the tractive efforts and/or braking efforts of powered units in the consist, such as remote control locomotives (RCL). For example, the data may include identification data that identifies a particular OCU and that is visually presented as a bar code, image, and/or text printed on the OCU or electronically displayed on the OCU. In another embodiment, the data may include identification data of the OCU that is encoded in an RFID tag coupled with the OCU. The identification data is optically scanned or electromagnetically read from the OCU to identify the OCU. In one embodiment, the RCL may receive control data that is wirelessly transmitted from the OCU and use the control data to control tractive effort and/or braking effort of the RCL. The RCL may receive and use the control data only from the OCU or OCUs that have provided identification data to the RCL and may prohibit other OCUs that have not provided the identification data to the RCL from controlling the RCL.

One or more embodiments of the disclosed systems can be retrofitted to an existing rail vehicle or rail vehicle consist. For example, data reading devices that optically and/or electromagnetically interrogate a tangible and non-transitory medium (e.g., a paper document, electronic display, RFID tag, OCU, and the like) to read data from the medium may be added to one or more locomotives or other cars of the rail vehicle consist. The data reading devices can be or communicatively coupled with microcontrollers, processors, or computing devices (referred to as “microcontrollers” herein) disposed on-board the rail vehicle. The data reading devices communicate the data acquired by optically scanning the medium or electromagnetically reading the data from an RFID tag to the microcontroller. In one embodiment, the microcontroller uses the data in connection with one or more operations of the rail vehicle, such as in formulating a trip profile or otherwise controlling tractive and/or braking effort of the consist. At least one technical effect of one or more embodiments described herein is the reading or scanning of data from a tangible and non-transitory medium, such as a train manifest document or an OCU, such that the data is used to control one or more operations of the rail vehicle. For example, a bar code or RFID tag on a document can be used to communicate data to the rail vehicle, which is then used by a propulsion subsystem of the rail vehicle to control tractive and/or braking efforts based on the data.

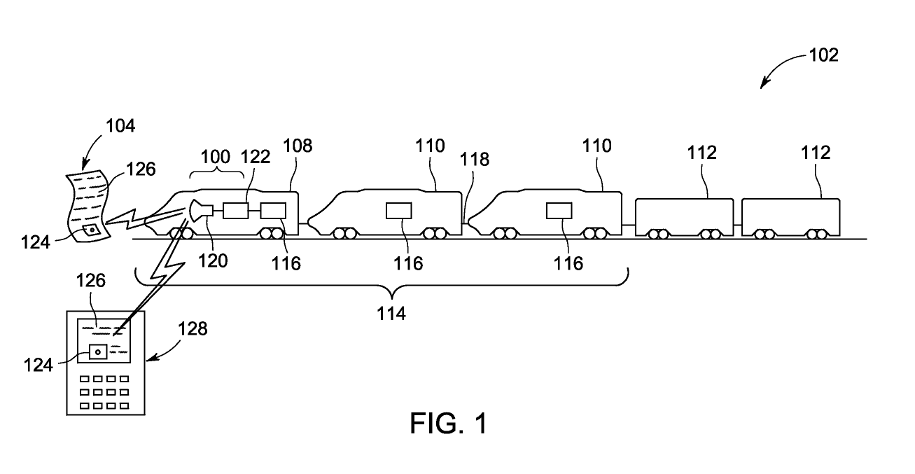

FIG. 1 is a schematic diagram of one embodiment of a data communication system 100 for a rail vehicle consist 102. As described above, in one embodiment, the communication system 100 permits optical and/or electromagnetic reading of data from a tangible and non-transitory medium 104, 128, such as a printed document (e.g., a train manifest document) or a handheld or human-portable electronic device (e.g., a mobile phone, personal digital assistant, or tablet personal computer). The optical and/or electromagnetic reading of the data can permit easier and more reliable communication of the data to the communication system 100 of the rail vehicle consist 102. For example, the physically recorded data may communicate the data faster and may avoid outside interference with communication of the data. Whereas wireless transmission of data can be relatively slow and/or unreliable, the reading of the data using an optical scanning device and/or RFID interrogating device can reliably communicate the data relatively fast.

The rail vehicle consist 102 includes several interconnected powered units 108, 110 and non-powered units 112. Alternatively, the rail vehicle consist 102 may include a single powered unit 108. “Powered units” refers to rail vehicles that are capable of self-propulsion, such as locomotives. “Non-powered units” refers to rail vehicles that are incapable of self-propulsion, but which may otherwise receive electric power for other services. For example, cargo cars, passenger cars, and other types of rail cars that do not propel themselves may be “non-powered units,” even though the cars may receive electric power for cooling, heating, communications, lighting, and the like. In the illustrated embodiment, the powered units 108, 110 represent locomotives joined with each other in a locomotive consist 114. The locomotive consist 114 represents a group of one or more locomotives in the rail vehicle consist 102. The locomotive consist 114 may be a subset of the rail vehicle consist 102 such that the locomotive consist 114 is included in the rail vehicle consist 102 along with additional powered and/or non-powered units in the rail vehicle consist 102. While the illustrated rail vehicle consist 102 only includes a single locomotive consist 114, alternatively the rail vehicle consist 102 may include two or more locomotive consists 114 joined together or interconnected by one or more intermediate powered or non-powered units that do not form part of the locomotive consists 114.

The powered units 108, 110 include a lead powered unit 108, such as a lead locomotive, and one or more trailing powered units 110, such as trail locomotives. As used herein, the terms “lead” and “trailing” are designations of different powered units, and do not necessarily reflect positioning of the powered units 108, 110, 112 in the rail vehicle consist 102 or the locomotive consist 114. For example, a lead powered unit may be disposed between two trailing powered units. Alternatively, the term “lead” may refer to the first powered unit in the rail vehicle consist 102 or the locomotive consist 114 and “trailing” powered units refer to powered units positioned after the lead powered unit. In another embodiment, the term “lead” refers to a powered unit that is designated for primary control of the locomotive consist 114 and “trailing” refers to powered units that are under at least partial control of the lead powered unit.

The powered units 108, 110 include a connection at each end of the powered unit 108, 110 to couple propulsion subsystems 116 of the powered units 108, 110 such that the powered units 108, 110 in the locomotive consist 114 function together as a single tractive unit. The propulsion subsystems 116 include electric and/or mechanical devices and components used to provide tractive effort that propels the powered units 108, 110 and braking effort that slows the powered units 108, 110. The propulsion subsystems 116 of the powered units 108, 110 in the locomotive consist 114 are connected and communicatively coupled with each other by a network connection 118. In one embodiment, the network connection 118 includes a net port and jumper cable that extends along the rail vehicle consist 102 and between the powered units 108, 110. The network connection 118 may be a cable that includes twenty seven pins on each end that is referred to as a multiple unit cable, or MU cable. Alternatively, a different wire, cable, or bus, or other communication medium, may be used as the network connection 118. For example, the network connection 118 may represent an Electrically Controlled Pneumatic (ECP) brake line, a fiber optic cable, or wireless connection.

In the illustrated embodiment, the communication system 100 is disposed on board the lead powered unit 108. Alternatively, the communication system 100 may be disposed on another powered unit 110 or a non-powered unit 112. In another embodiment, multiple communication systems 100 are provided on the consist 102 with two or more of the communication systems 100 located on different powered and/or non-powered units 110, 112. The communication system 100 includes a data reading device 120 communicatively coupled to a processing module 122. The data reading device 120 is an electronic component that reads the data from the tangible and non-transitory medium 104, 128. The data reading device 120 interrogates the medium 104, 128 with light waves or electromagnetic waves to the medium 104, 128 to optically scan or electromagnetically read the data from the medium 104. In one embodiment, the data is not wirelessly transmitted or otherwise actively transmitted by the medium 104, 128 on which or in which the data is recorded, printed, or otherwise represented. For example, the medium 104, 128 may not wirelessly transmit the data to the data reading device 120.

The data reading device 120 reads data from the tangible and non-transitory medium 104, 128 that is spaced apart from the data reading device 120 but is located on-board the rail vehicle consist 102 in one embodiment. For example, the data reading device 120 may read the data from the medium 104, 129 only while the medium 104, 128 is located in the same powered or non-powered unit 110, 112 of the rail vehicle consist 102. By “on-board,” it is meant that the data reading device 120 may be located in an interior compartment (e.g., cab) of the powered or non-powered unit 110, 112 or disposed outside of, but coupled to, the powered or non-powered unit 110, 112. For example, the data reading unit 120 may be affixed to the outside of the powered or non-powered unit 110, 112.

In one embodiment, the tangible and non-transitory medium 104, 128 is portable and/or decoupled from rail infrastructure. For example, the medium 104, 128 may be a handheld or human-portable object that is carried by a single human operator without assistance from additional machinery or tools, such as a lifting or support mechanism without which a human operator of average strength and size would be unable to lift and carry the medium 104, 128. The medium 104, 128 can be decoupled from rail infrastructure when the medium 104, 128 is not affixed, coupled, joined, or otherwise mechanically engaged with a rail, track, wayside equipment, another rail vehicle consist, and the like. For example, the medium 104, 128 may be decoupled from rail infrastructure when a human operator of average strength and size can lift, carry, or otherwise move the medium 104, 128 relative to a rail, track, wayside equipment, or rail vehicle consist without assistance from the lifting or support mechanisms described above.

The data reading device 120 communicates the data acquired from the medium 104, 128 to the processing module 122. The processing module 122 may use the data in connection with one or more operations of the rail vehicle consist 102. For example, the processing module 122 may use the data to form or change a trip profile that controls tractive and/or braking efforts of the powered units 110 in the rail vehicle consist 102 during a trip. Alternatively, the data may be used for other purposes, such as to track inventory of cargo, a composition of the different powered and/or non-powered units 110, 112 in the consist 102, and the like.

The data reading device 120 can acquire the data from the medium 104, 128 while the medium 104, 128 is spaced apart from the data reading device 120 without the medium 104, 128 wirelessly transmitting the data. For example, the medium 104, 128 may not be coupled or engaged with the data reading device 120, such as by one or more connectors, cables, busses, and the like. By way of example, the medium 104, 128 may be spaced apart from the data reading device 120 by anywhere from less than one inch (2.54 centimeters) to one to two feet (30.5 centimeters to 60.0 centimeters) away from the data reading device 120. However, other distances may be used and the above examples are not intended to be limited on all embodiments described herein. The medium 104, 128 may be located on-board the consist 102, such as inside the same powered and/or non-powered unit 110, 112 in which the communication system 100 is disposed, when the data reading device 120 interrogates or scans the medium 104, 128 to acquire the data.

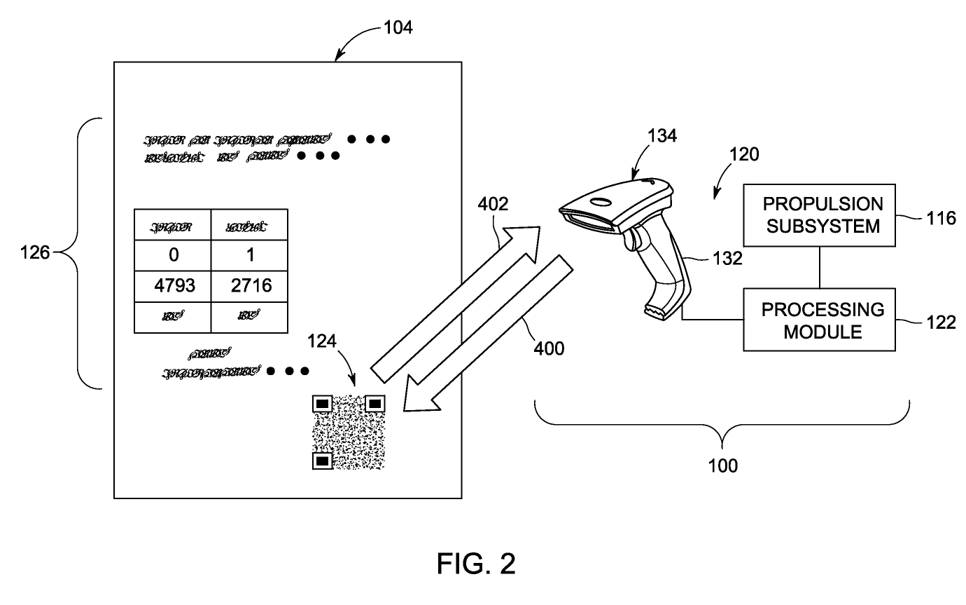

FIG. 2 is an illustration of one embodiment of the communication system 100 that includes an optical scanner as the data reading device 120. The data reading device 120 is illustrated as a handheld optical scanner, but alternatively may be a non-handheld optical scanner, such as an optical scanner that is affixed to one or more structures or components within a powered unit 110 and/or non-powered unit 112 (shown in FIG. 1) of the consist 102 (shown in FIG. 1). The data reading device 120 optically reads an image 124 that is visually presented on the medium 104. The data reading device 120 includes a reader unit 134 and a base 132 that receives the reader unit 134. The base 132 is used to at least one of mechanically or electrically install the data reading device 120 on a rail vehicle. As shown in FIG. 2, the base 132 may be communicatively coupled by one or more wired and/or wireless connections with the processing module 122.

The image 124 may be an optical machine-readable representation of the data, such as a bar code. The bar code can be linear or one-dimensional bar code (such as a U.P.C. bar code), a matrix or two-dimensional bar code (such as an Aztec bar code or QR bar code), a color bar code (such as an image), and the like. The image 124 shown in FIG. 2 is a two-dimensional bar code. The medium 104 can represent a paper document, such as a train manifest. The medium 104 can include human-readable text 126 that is printed on the medium 104. When the train manifest is handed to an operator of the rail vehicle consist 102, the operator may position the medium 104 relatively close to the data reading device 120 in order for the data reading device 120 to interrogate the medium 104 and acquire the data represented by or contained in the image 124. In the illustrated embodiment, the medium 104 is a printed document, such as a paper document with the image 124 printed on the document using ink. Alternatively, the medium 104 may be replaced by the medium 128, such as a display device of an electronic device (e.g., a mobile phone, personal digital assistant, or tablet personal computer). The display device may display the image 124 (such as an electronically displayed bar code) such that the data reading device 120 can optically scan the image 124 to obtain the data. While the discussion herein focuses on the medium 104, the discussion may equally apply to the medium 128.

The reader unit 134 interrogates the medium 104 with light beams 400 (e.g., light waves transmitted by the data reading device 120 toward the medium 104) in order to acquire the data that is represented by or contained in the image 124. At least some of the light beams 400 are reflected off of the image 124 as reflected beams 402. The light beams 400 that strike different portions of the medium 104 and/or image 124 may be reflected differently based on which part of the medium 104 or image 124 that the light beams 400 strike. The reflected beams 402 are reflected off the image 124 back toward the data reading device 120. The data reading device 120 receives the reflected beams 402 and translates the reflected beams 402 into the data represented by the image 124. For example, the data reading device 120 interprets the differently reflected beams 402 in order to identify or discern the data contained in or represented by the image 124. The image 124 provides the data to the data reading device 120 in a non-wirelessly transmitted manner, or in a manner where the data is contained within the medium 104 as opposed to being wirelessly transmitted in a wireless TCP/IP network or transmitted from the medium 104, 128 to the data reading device 120.

The data reading device 120 is communicatively coupled with the processing module 122, such as by one or more one or more wired or wireless connections. For example, the data reading device 120 may be a handheld and/or portable bar code scanner that is coupled with the processing module 122 by a wire or cable. Alternatively, the data reading device 120 may be a handheld and/or portable bar code scanner that is wirelessly connected with the processing module 122 over a local area network or other short-range wireless connection (e.g., Bluetooth). The reading range of the data reading device 120 may be limited to a relatively short range, such as one inch (2.54 centimeters) to one to two feet (30.5 centimeters to 60.0 centimeters). For example, the data reading device 120 may be unable to reach the data from the medium 104, 128 when the medium 104, 128 is located relatively far away, such as farther than two feet (60.0 centimeters) from the data reading device 120.

As described below, the processing module 122 receives the acquired data from the data reading device 120 and uses the data in connection with one or more operations of the consist 102 (shown in FIG. 1). By way of example, the processing module 122 may be communicatively coupled with one or more propulsion subsystems 116 of the consist 102 and may use the acquired data to determine a trip profile for the consist 102 and control tractive and/or braking efforts of the propulsion subsystem 116 based on the trip profile. However, other uses of the data may be realized.

Alternatively, the data reading device 120 may be an optical character recognition (OCR) device. Such a data reading device 120 can optically scan the human readable text 126 on the medium 104 (or the medium 128) to obtain the data. For example, the data may be printed on a train manifest document or electronically displayed on an electronic device as text 126 that is readable by a human operator. The data reading device 120 scans the text 126 by transmitting light beams 400 and receiving reflected beams 402 to identify the text 126. The data reading device 120 converts the identified text 126 into the data.

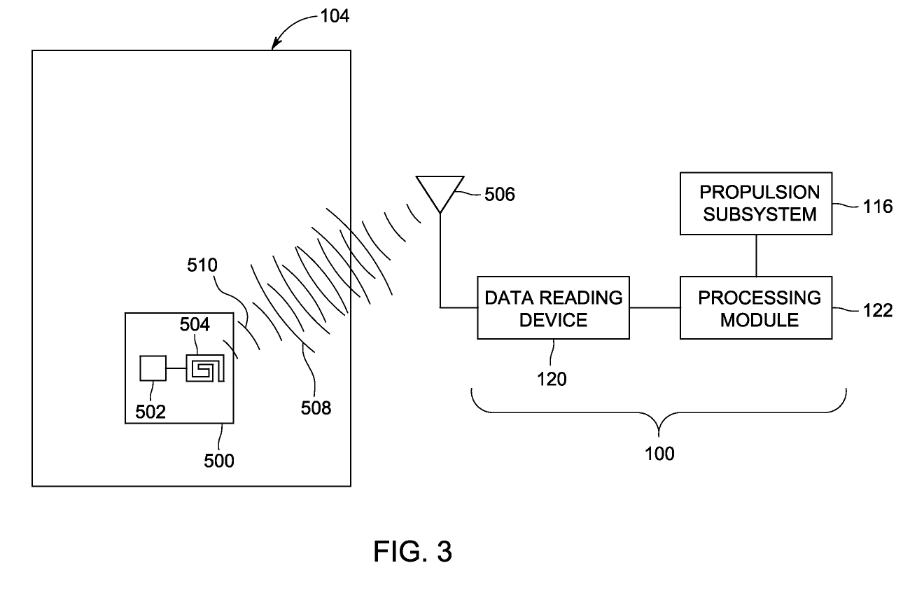

FIG. 3 is an illustration of another embodiment of the communication system 100 that includes an RFID interrogator device or reader (e.g., “RF interrogator”) as the data reading device 120. In the illustrated embodiment, the data reading device 120 is an electromagnetic data reading device that transmits and/or receives electromagnetic waves to read the data from the medium 104. The data may be encoded or contained in an RFID tag or label 500 that includes a controller 502 (such as a microchip) and an antenna 504. For example, the image 124 shown in FIG. 1 may represent an RFID tag or label 500 that is affixed to a document, such as a manifest.

The data reading device 120 includes an antenna 506 that generates an interrogation field toward the RFID tag 500. Similar to the reader unit 134 (shown in FIG. 2), the antenna 506 may be coupled with a base (e.g., that may be similar to the base 132 shown in FIG. 2) that is communicatively coupled with the processing module 122. The interrogation field includes electromagnetic waves 508 transmitted by the antenna 506. The transmitted electromagnetic waves 508 may be the same frequency or the data reading device 120 may sweep through a range of frequencies when transmitting the electromagnetic waves 508. For example, the frequency of the transmitted electromagnetic waves 508 may vary over time. The RFID tag 500 may be an active or passive tag. With respect to active RFID tags 500, the RFID tag 500 may include or be coupled with a power source, such as a battery. The battery may be included in the same package as the controller 502 and/or antenna 504. When the active RFID tag 500 receives the electromagnetic waves 508 transmitted by the antenna 506 of the data reading device 120, the controller 502 causes the antenna 504 to wirelessly transmit responsive electromagnetic waves 504. The antenna 504 is powered by the power source. Alternatively, in the case of a passive RFID tag 500, the antenna 504 receives energy from the transmitted electromagnetic waves 508. The received energy inductively powers the controller 502 such that the controller 502 directs the antenna 504 to transmit the electromagnetic waves 510 to the antenna 506 of the data reading device 120.

The electromagnetic waves 510 transmitted by the RFID tag 500 include or represent the data associated with the RFID tag 500. The antenna 506 of the data reading device 120 receives the responsive electromagnetic waves 510 and determines the data from the received responsive electromagnetic waves 510.

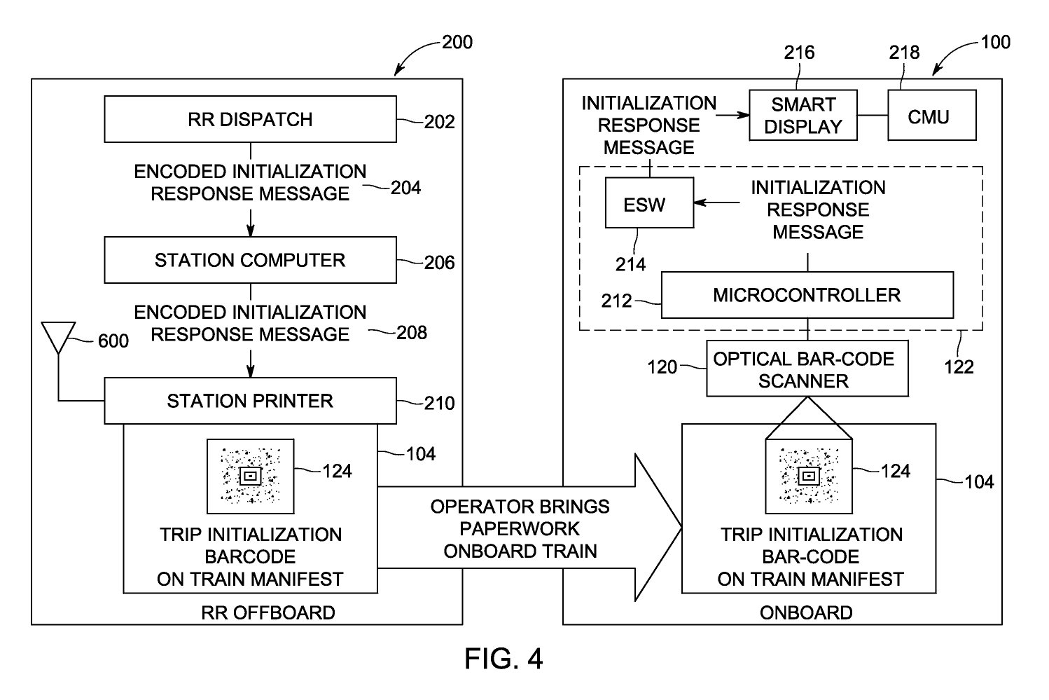

FIG. 4 is a schematic illustration of one embodiment of a data generation system 200 and the communication system 100. FIG. 4 illustrates the flow of the data from a point of origin, such as a railroad dispatch 202 (“RR Dispatch”), to a point of destination, such as the processing module 122 on the rail vehicle consist 102 (shown in FIG. 1). FIG. 4 is described in terms of communicating a trip profile as the data to the rail vehicle consist 102 for a software application of the rail vehicle consist 102 that uses the trip profile to control tractive and/or braking efforts of the rail vehicle consist 102 during an upcoming trip of the rail vehicle consist 102.

The railroad dispatch 202 can represent a computer processor or other computer device that generates the data. For example, the railroad dispatch 202 may include a computer having one or more input devices for receiving the data from a human operator and/or from one or more sensors or other computers. The railroad dispatch 202 may be located in an office or town remote from the rail vehicle consist 102 or in the same rail yard in which the rail vehicle consist 102 is located. The railroad dispatch 202 may create the data in connection with a request for a trip profile. For example, an operator may input a request, such as a trip initialization request, for a trip profile. The trip profile may be used by an energy management or other software application on the rail vehicle consist 102, such as the Trip Optimizer™ software application provided by General Electric Company, to control propulsion operations of the rail vehicle consist 102 during an upcoming trip. (For example, the trip profile may be used by the energy management system as part of the basis for generating a trip or mission plan for the rail vehicle consist, where the rail vehicle consist is controlled based on the trip or mission plan as the rail vehicle consist travels along a route.) The trip profile may be based, at least in part, on the cargo that is carried by the rail vehicle consist 102. For example, the rail vehicle consist 102 may change propulsion operations differently when different cargoes are carried by the rail vehicle consist 102 over the same trip.

In response to the request, the railroad dispatch 202 communicates a response message 204 (“Encoded Initialization Response Message”) to a station processing module 206 (“Station Computer”). The response message 204 includes the data. Alternatively, the response message 204 may include a field pointer that directs the station processing module 206 to a location where the data is stored. The station processing module 206 may be a computer processor or computer that encodes the data into a form that is readable by the data reading device 120. For example, if the data reading device 120 is an optical scanning device that optically scans the image 124 to obtain the data, then the station processing module 206 may determine the appearance and contents of the image 124 based on the data. Alternatively, if the data reading device 120 is an OCR scanning device, then the station processing module 206 may determine the human-readable text 126 (shown in FIG. 1) that includes the data. In another embodiment, if the data reading device 120 is an electromagnetic scanning device, such as an RFID interrogator, then the station processing module 206 may determine the coding of the data in the controller 502 (shown in FIG. 2) of the RFID tag 500 (shown in FIG. 2). For example, the station processing module 206 may determine the bits that are to be stored on the RFID tag 500 in order to record the data in the RFID tag 500.

The station processing module 206 communicates an encoded response message 208 (“Encoded Initialization Response Message”) to a printing device 210 (“Station Printer”). The encoded response message 208 includes the data in an encoded form. By “encoded form,” it is meant that the data that is output from the station processing module 206 has been converted or changed from one format or language to another format or language. For example, the response message 204 that is input into the station processing module 206 may be incapable of being used by a printer or handheld electronic device to visually present the image 124, such as by printing the image 124 onto paper or displaying the image on a handheld electronic device. Conversely, the encoded response message 208 is in a different, encoded form such that the encoded response message 208 can be used by a printer or handheld electronic device to create the image 124.

The printing device 210 is an electronic device that converts the encoded response message 208 into the image 124. For example, the printing device 210 may be a laser jet printer (or other device capable of printing the image 124 on a paper document) that prints the image 124 with ink onto the medium 104, such as a paper document. In the illustrated embodiment, the medium 104 is one or more pages of a train manifest document (“Trip Initialization Barcode On Train Manifest”). Additional human-readable text 126 (shown in FIG. 1) also may be printed onto the medium 104 by the printing device 210. Alternatively, the printing device 210 may be a transceiver that communicates the image 124 to a handheld electronic device. For example, the printing device 210 may communicate the image 124 over a wired or wireless connection to a mobile phone, personal digital assistant, and the like, so that the image 124 can be displayed on the phone or personal digital assistant.

In another embodiment, the printing device 210 is a programming device that programs the data into the RFID tag 500 (shown in FIG. 2). For example, the printing device 210 may include an antenna 600 that transmits the data to the RFID tag 500 for storage therein. The RFID tag 500 may be the medium 104 or the RFID tag 500 be attached or affixed to the medium 104.

Once the image 124 (e.g., bar code or RFID tag/label) is created by the printing device 210, the medium 104 or 128 is carried to the communication system 100. For example, the medium 104 or 128 may be a handheld object capable of being carried by a single human operator. The medium 104 or 128 is carried to the data reading device 120 of the communication system 100. In the illustrated embodiment, the data reading device 120 is referred to as an “Optical Bar-Code Scanner.” Alternatively, as described herein, the data reading device 120 may be an RFID interrogation or data reading device. The data reading device 120 scans or reads the image 124 from the medium 104 to obtain the data. In another embodiment, the data reading device 120 scans or reads the image 124 from the medium 128 (shown in FIG. 1) to obtain the data. Alternatively, the data reading device 120 may scan or read the human-readable text printed on the medium 104 or 128 to obtain the data.

The data is communicated from the data reading device 120 to the processing module 122. In the illustrated embodiment, the processing module 122 includes a microcontroller 212, such as a computer microprocessor or processor. The microcontroller 212 examines the data received from the data reading device 120 to determine the destination of the data. Different parts of the data may be directed or addressed to different components of the rail vehicle consist 102. The microcontroller 212 may determine where to send all or part of the data based on the contents of the data. For example, if the data includes cargo content information and/or a trip profile for the rail vehicle consist 102, then the microcontroller 212 may communicate the data (or a portion thereof) to a software module 214 that uses the data.

The software module 214 (“ESW”) represents a set of instructions for a computer processor, such as the microcontroller 212, that are stored on a tangible and non-transitory computer readable medium, such as a computer hard drive, ROM, RAM, EEPROM, flash drive, CD, DVD, and the like. The software module 214 may be embodied in one or more software applications that are stored on a computer memory. The software module 214 examines the data received from the microcontroller 212 and determines how the data is to be used to control one or more operations of the rail vehicle consist 102 (shown in FIG. 1). For example, the software module 214 may determine that the data is to be used to control tractive and/or braking efforts provided by one or more propulsion subsystems 116 (shown in FIG. 1) of the rail vehicle consist 102 during an upcoming trip of the rail vehicle consist 102. Alternatively, the software module 214 may determine that the data is to be used for other operations, such as monitoring the contents of cargo received or offloaded by the rail vehicle consist 102. The above examples are not limitations on how the data may be used but are provided merely as example embodiments.

In the illustrated embodiment, the processing module 122 is coupled with a display device 216 (“Smart Display”). The processing module 122 may direct the display device 216 to visually present the data to an operator of the rail vehicle consist 102 (shown in FIG. 1). For example, the display device 216 may be a monitor, touchscreen, or other electronic device capable of visually presenting information. The display device 216 may present the data to the operator so that the operator is aware of the data and/or so that the operator can verify the accuracy and/or completeness of the data.

The processing module 122 also may be coupled with a controller processing module 218 (“CMU”). The controller processing module 218 may be a computer processor or microprocessor that operates based on one or more sets of instructions stored on a tangible and non-transitory computer readable storage medium, such as or similar to the software module 214. The controller processing module 218 may use the data to control operations of the rail vehicle consist 102 (shown in FIG. 1). For example, the controller processing module 218 may be communicatively coupled with the propulsion subsystems 116 (shown in FIG. 1) of the powered units 108, 110 (shown in FIG. 1). The controller processing module 218 can examine the data and change the tractive and/or braking efforts of one or more of the powered units 108, 110 based on the data and/or a trip profile for the rail vehicle consist 102. For example, if the rail vehicle consist 102 is approaching a steep incline and the data indicates that the rail vehicle consist 102 is carrying significantly heavy cargo, then the controller processing module 218 may direct one or more of the powered units 108, 110 to increase the tractive efforts supplied by the powered units 108, 110. Conversely, if the rail vehicle consist 102 is carrying a smaller cargo load based on the data, then the controller processing module 218 may direct the powered units 108, 110 to increase the supplied tractive efforts by a smaller amount than the tractive efforts would otherwise be increased if the data indicated a heavier cargo load. The tractive and/or braking efforts may be changed in response to other factors, such as changes in the track that the rail vehicle consist 102 travels along, regulatory requirements (e.g., emission limits) of the regions through which the rail vehicle consist 102 travels, and the like, and based on the data.

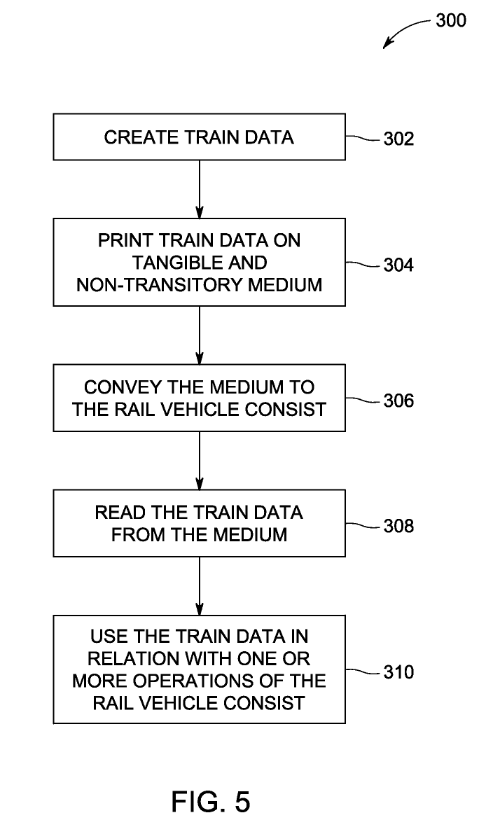

FIG. 5 is a flowchart of one embodiment of a method 300 for communicating data with a rail vehicle consist. The method 300 may be used in conjunction with one or more embodiments of the communication system 100 (shown in FIG. 1) described herein.

At 302, data is created. For example, an operator may input data, such as details about the cargo being transported by a rail vehicle consist, into a computer device. Alternatively, the data may be automatically received from sensors or other input devices.

At 304, the data is printed onto a tangible and non-transitory medium. For example, the data may be printed as an image, such as a bar code, or human-readable text onto a paper document, such as a train manifest document. Alternatively, the data may be printed on another object. In another embodiment, the data may be displayed on a display device of an electronic component, such as a handheld electronic device. Alternatively, the data may be programmed onto an RFID tag or label. For example, instead of printing the data, the data may be stored on an RFID tag or label.

At 306, the medium that contains the data is conveyed to the rail vehicle consist. For example, the paper document (e.g., a train manifest), handheld electronic device, or RFID tag may be carried by a single human operator to the rail vehicle consist.

At 308, the data is read from the medium. For example, the data may be optically scanned from the paper document or electromagnetically read from the RFID tag or label. In one embodiment, the data is optically scanned from an image, such as a bar code, or from human-readable text, such as through OCR techniques. Alternatively, the data is electromagnetically read by an RFID interrogating device.

At 310, the data is used in relation with one or more operations of the rail vehicle consist. For example, after reading the data, the data may be used to formulate a trip profile for an upcoming trip of the rail vehicle consist, where the trip profile is used to change or control propulsion of the rail vehicle consist during the trip. Alternatively, the data may be used to inventory or track the contents of cargo stored on the rail vehicle consist. The data may be used for other operations associated with the rail vehicle consist than those listed above.

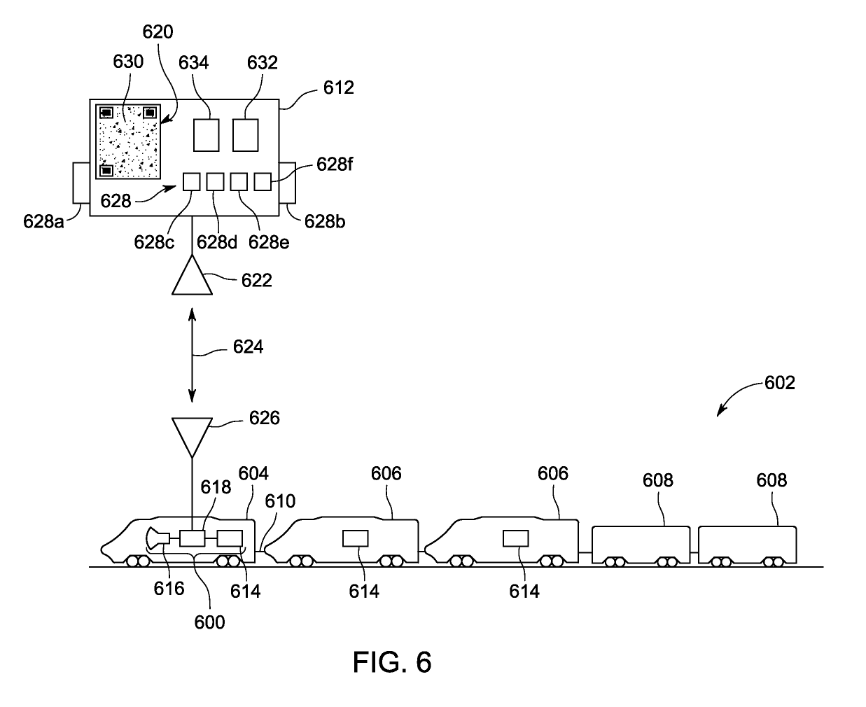

FIG. 6 is a schematic diagram of one embodiment of a data communication system 600 for a rail vehicle consist 602. The communication system 600 can optically and/or electromagnetically reads identification data associated with an OCU 602 in order to determine which OCUs 602 can control tractive efforts and/or braking efforts of the consist 602 and/or one or more rail vehicles (e.g., units 604, 606, 608) of the consist 602. As described above, a “consist” can include a single vehicle (e.g., a single rail vehicle) or multiple rail vehicles coupled together. In the illustrated embodiment, the rail vehicle consist 602 includes several interconnected powered units 604, 606 and non-powered units 608. As described above, “powered units” refers to rail cars that are capable of self-propulsion, such as locomotives and “non-powered units” refers to rail cars that are incapable of self-propulsion, but which may otherwise receive electric power for other services. The powered units 604, 606 include a lead powered unit 604, such as a lead locomotive, and one or more trailing powered units 606, such as trail locomotives.

In the illustrated embodiment, the powered units 604, 606 represent RCL joined with each other in a locomotive consist 610. As described above, an RCL includes a locomotive that may be remotely controlled by an electronic device, such as an OCU 612. For example, one or more of the powered units 604, 606 may wirelessly receive control data 624 from the OCU 612 and may change tractive efforts and/or braking efforts based on the received control data 624. The OCU 612 includes a control module 632 and a tangible and non-transitory computer readable storage medium 634 (e.g., a computer hard drive, flash drive, or other tangible memory). The control module 632 is operably coupled with an operator interface 628 that receives input from an operator. The control module 632 operates based on one or more sets of instructions stored on the medium 634 (e.g., software) in order to form control data 624 that is used to control operations of one or more rail vehicles of the consist 602. The control module 632 is operably coupled with a transceiver 622, such as an antenna and/or radio device, that wirelessly transmits the control data 624 to a transceiver 626 of the rail vehicle consist 602. By “remote” or “remotely,” it is meant that the OCU 612 may transmit the control data 624 to control operations (e.g., tractive and/or braking operations) of the rail vehicle consist 602 (e.g., by controlling one or more of the powered units 604, 606) when the OCU 612 is located off board the rail vehicle consist 602 and/or is moving relative to the rail vehicle consist 602.

The powered units 604, 606 include a connection at each end of the powered unit 604, 606 to couple propulsion subsystems 614 of the powered units 604, 606 such that the powered units 604, 606 in the locomotive consist 610 function together as a single tractive unit. The propulsion subsystems 614 include electric and/or mechanical devices and components used to provide tractive effort that propels the powered units 604, 606 and braking effort that slows the powered units 604, 606. The propulsion subsystems 614 of the powered units 604, 606 in the locomotive consist 610 are connected and communicatively coupled with each other by a network connection 610, which may be similar to the network connection 118 (shown in FIG. 1).

In the illustrated embodiment, the communication system 600 is disposed on board the lead powered unit 604. Alternatively, the communication system 600 may be disposed on another powered unit 606 or a non-powered unit 608. In another embodiment, multiple communication systems 600 are provided on the consist 602 with two or more of the communication systems 600 located on different powered and/or non-powered units 606, 608. The communication system 600 includes a data reading device 616 communicatively coupled to a processing module 618. The data reading device 616 is an electronic component that reads the data from a tangible and non-transitory medium 620 that is included in the OCU 612. While the data reading device 616 is shown as being disposed on the powered unit 604, alternatively, the data reading device 616 (and/or one or more other components of the system 600 or the system 600) may be disposed on another powered unit 606.

The medium 620 may include an exterior portion of the OCU 612, such as a section of the outer housing of the OCU 612. Alternatively, the medium 620 may represent an RFID tag coupled to the OCU 612. In another embodiment, the medium 620 may represent an electronic display of the OCU 612 that presents an electronically displayed image. The control module 612 directs the medium 620 to display the image 630. For example, in an embodiment where the medium 620 is an electronic display, the control module 612 may be operably coupled with the display such that the control module 612 conveys instructions to the display to visually present the image 630. In another embodiment, the medium 620 may represent a programmable RFID tag that can be encoded and/or re-coded with the identification data by the control module 612. The control module 612 may encode the identification data in the medium 620 such that the medium 620 provides the identification data to the data reading device 616 when the medium 620 is electromagnetically interrogated by the data reading device 616. Alternatively, the medium 620 may represent another tangible object, such as a paper document, fob, and the like, that is coupled with the OCU 612.

In one embodiment, the one or more sets of instructions stored on the medium 634 and that direct operations of the control module 632 may be used to modify an existing OCU 612 to visually present the identification data on the medium 620 (e.g., an electronic display). For example, the medium 634 of an existing OCU 612 that does not include a bar code or other image that represents the identification data of the OCU 612 can be programmed with software that directs the medium 620 (e.g., the display) to visually present the bar code or other image that represents the identification data of the OCU 612.

The data reading device 616 interrogates the medium 620with light waves or electromagnetic waves to optically scan or electromagnetically read data from the medium 620. In one embodiment, the data is not wirelessly transmitted or otherwise actively transmitted by the OCU 612. For example, the OCU 612 may not wirelessly transmit the data to the data reading device 616. The data reading device 616 reads data from the OCU 612 that is spaced apart from the data reading device 616 but is located on-board the rail vehicle consist 602 in one embodiment.

In one embodiment, the OCU 612 portable and/or decoupled from rail infrastructure. For example, the OCU 612 may be a handheld object that is carried by a single human operator without assistance from additional machinery or tools, such as a lifting or support mechanism without which a human operator of average strength and size would be unable to lift and carry the OCU 612. The OCU 612 can be decoupled from rail infrastructure when the OCU 612 is not affixed, coupled, joined, or otherwise mechanically engaged with a rail, track, wayside equipment, another rail vehicle consist, and the like.

The data reading device 616 can read identifying information of the OCU 612 by optically scanning or electromagnetically interrogating the medium 620 of the OCU 612. The identifying information may be a unique identifier, number, or other label that can be used to distinguish the OCU 612 and/or control data that is wirelessly transmitted from the OCU 612 from other OCUs 612 and/or control data from other OCUs 612. The data reading device 616 communicates the identification data acquired from the OCU 612 to the processing module 618. The processing module 618 may use the identification data to distinguish the OCU 612 from one or more other OCUs 612.

As described above in connection with the communication system 100 shown in FIG. 2, the data reading device 616 may include an optical scanner, such as a handheld optical scanner or a non-handheld optical scanner, such as an optical scanner that is affixed to one or more structures or components within a powered unit 604, 606 and/or non-powered unit 608. The data reading device 616 can optically read an image 630 that is visually presented on the OCU 612, such as by being printed or electronically displayed on the OCU 612.

As described above, the image 630 may be an optical machine-readable representation of the data, such as a bar code. The bar code can be any one or more of a linear or one-dimensional bar code (such as a U.P.C. bar code), a matrix or two-dimensional bar code (such as an Aztec bar code or QR bar code), a color bar code (such as an image), and the like. An operator may take the OCU 612 onto the powered unit 604 and position the OCU 612 relatively close to the data reading device 616 in order for the data reading device 616 to optically acquire the data represented by or contained in the image 630. The data reading device 616 can interrogate the medium 620 of the OCU 612 with light beams in order to acquire the data that is represented by or contained in the image 630. As described above, reflections of the light beams off of the image 630 are used to identify the data represented by the image 630.

The data reading device 616 is communicatively coupled with the processing module 618, such as by one or more one or more wired or wireless connections. For example, the data reading device 616 may be a handheld and/or portable bar code scanner that is coupled with the processing module 618 by a wire or cable. Alternatively, the data reading device 616 may be a handheld and/or portable bar code scanner that is wirelessly connected with the processing module 618 over a local area network or other short-range wireless connection (e.g., Bluetooth). The reading range of the data reading device 616 may be limited to a relatively short range, such as one inch (2.54 centimeters) to one to two feet (30.5 centimeters to 60.0 centimeters). For example, the data reading device 616 may be unable to reach the data from the OCU 612 is located relatively far away, such as farther than two feet (60.0 centimeters) from the data reading device 616. Alternatively, the data reading device 616 may be an optical character recognition (OCR) device and the image 630 may represent text, such as machine or human readable text. Such a data reading device 616 can optically scan the image 630 to obtain the identifying data and/or other data represented by the image 630. The data reading device 616 converts the identified text into the data.

In another embodiment, the data reading device 616 may include an RFID interrogator device or reader (e.g., “RF interrogator”), similar to as described above in connection with FIG. 3. The medium 620 may represent an RFID tag or label that is similar to the label 500 shown in FIG. 3. The identifying data of the OCU 612 may be encoded or contained in the RFID tag or label. The data reading device 616 includes an antenna (e.g., the antenna 506 shown in FIG. 3) that generates an interrogation field toward the RFID tag. The interrogation field includes electromagnetic waves transmitted by the antenna, as described above. The RFID tag may be an active or passive tag. The RFID tag wirelessly transmits responsive electromagnetic waves back toward the data reading device 616 when interrogated by the data reading device 616. The antenna 504 is powered by the power source. The electromagnetic waves transmitted by the RFID tag include or represent the data associated with the RFID tag. For example, the electromagnetic waves may include or represent the identifying information of the OCU 612. The antenna of the data reading device 616 receives the responsive electromagnetic waves and determines the data from the received responsive electromagnetic waves.

In one embodiment, the processing module 618 may use identification data obtained from the OCU 612 to distinguish the OCU 612 from a plurality of other OCUs 612 as a master OCU 612. A “master” OCU 612 represents an OCU 612 that can control operations of the rail vehicle consist 602, such as the tractive efforts and/or braking efforts of one or more powered units 604, 606, while an OCU 612 other than the master OCU 612 (e.g., a “non-master” OCU 612) may be prohibited by the processing module 618 from controlling operations of the rail vehicle consist 602. In an embodiment where the consist 602 includes a single rail vehicle (e.g., a single powered unit 604 or 606) and/or a single powered unit 604 or 606, the master OCU 612 can control operations of the single rail vehicle or the single powered unit 604 or 606 in the consist 602. In one embodiment, more than one master OCU 612 may be identified. For example, a primary master OCU 612 and a secondary, or backup, master OCU 612 also may be identified. The terminology of “first OCU” as used herein is not intended to limit which powered units 604, 606 may be controlled by the “first OCU.” Instead, the term “first OCU” is used to distinguish one OCU 612 from one or more other OCUs 612. For example, a “first OCU” may be used to control operations of a powered unit 606 other than the powered unit 604.

The data reading device 616 can acquire the identification data from the OCU 612 while the OCU 612 is spaced apart from the data reading device 616 without the OCU 612 wirelessly transmitting or conveying the data. For example, the OCU 612 may not be coupled or engaged with the data reading device 616, such as by one or more connectors, cables, busses, and the like. The OCU 612 may not wirelessly transmit the identification data, such as in a wireless network or using infrared light, in one embodiment. The OCU 612 may be spaced apart from the data reading device 616 by anywhere from less than one inch (2.54 centimeters) to one to two feet (30.5 centimeters to 60.0 centimeters) away from the data reading device 616. However, other distances may be used and the above examples are not intended to be limited on all embodiments described herein. The OCU 612 may be located on-board the consist 602, such as inside the same powered and/or non-powered unit 606, 608 in which the communication system 600 is disposed, when the data reading device 616 interrogates or scans the OCU 612 to acquire the identification data.

Once the processing module 618 has identified a master OCU 612, the master OCU 612 wirelessly transmits the control data 624 from the transceiver 622 of the OCU 612 to the transceiver 626 of the rail vehicle consist 602. The transceiver 626 is communicatively coupled with the processing module 618 of the rail vehicle consist 602, which uses the received control data 624 to control (e.g., change or maintain) operations of the rail vehicle consist 602, such as by controlling tractive efforts and/or braking efforts of one or more of the powered units 604, 606. The OCU 612 includes an operator interface 628 having one or more input devices 628a-f that are used by a human operator to form the control data 624. The input devices 628a and 628b can include rotatable knobs that are rotated to change throttle and/or brake settings of the rail vehicle consist 602. The input devices 628c, 628d, 628e, and/or 628f can include one or more buttons, switches, knobs, or other actuators that may be engaged by the operator to cause the OCU 612 to form the control data 624 that is transmitted to the rail vehicle consist 602. The control module 632 monitors the input of an operator using the operator interface 628 (e.g., “operator input”) and forms the corresponding control data 624 based on the operator input.

The network connection 610 of the rail vehicle consist 602 may communicate the control data 624 that is received by one powered unit 604, 606 and/or non-powered unit 608 to a different powered unit 604, 606. For example, the powered unit 604 may receive control data 624 that changes a throttle setting of the powered unit 606. The control data 624 can be transmitted from the powered unit 604 to the powered unit 606 through the network connection 610.

In one embodiment, data other than or in addition to the identification data may be read or scanned from the OCU 612 by the data reading device 616. For example, one or more communication parameters may be read or scanned. The communication parameters can include information that is used by the processing module 618 to receive and process control data and/or other data from the OCU 612. The communication parameters can include encryption keys that are used to decrypt encrypted communications from the OCU 612, frequency bands or channels that are used by the OCU 612 to communicate with the processing module 618, and the like. Alternatively, one or more other types of data may be conveyed by reading or scanning the OCU 612.

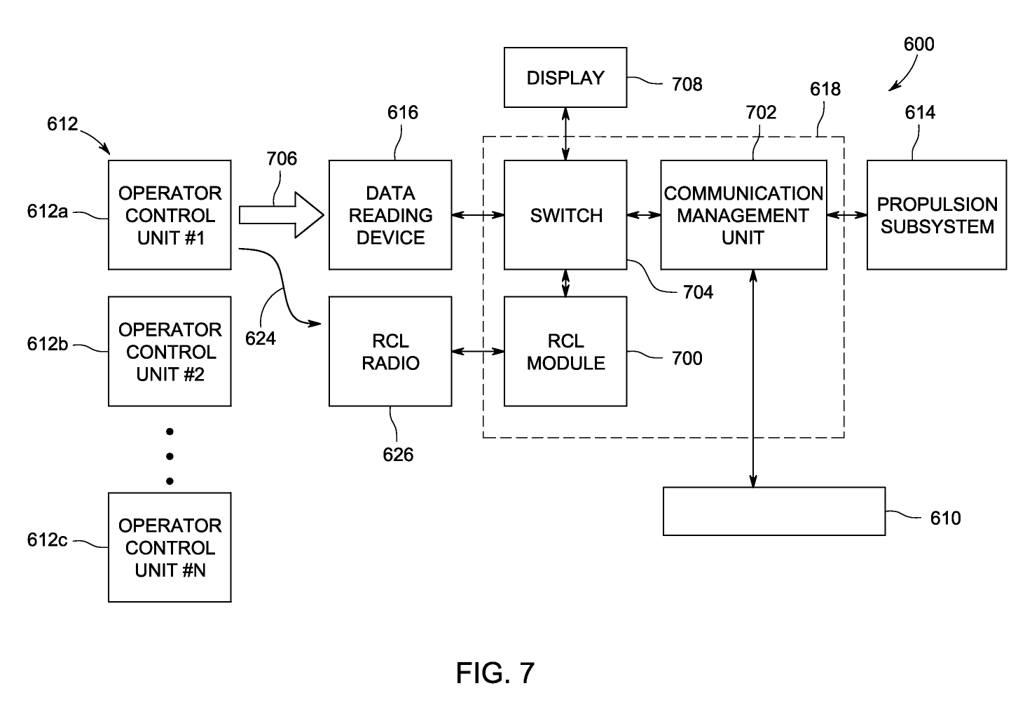

FIG. 7 is another schematic diagram of the communication system 600 shown in FIG. 6. As shown in FIG. 7, the processing module 618 includes an RCL module 700 and a communication management unit 702 communicatively coupled with a switch 704 by one or more wired and/or wireless connections. The processing module 618, the RCL module 700, the communication management unit 702, and/or the switch 704 may represent one or more computer processors, controllers, integrated circuits, hard wired logic, or other electronic logic-based devices that operate based on one or more sets of instructions (e.g., software applications) stored on a computer readable storage medium, such as a computer memory (e.g., hard drive, flash drive, ROM, RAM, and the like). For example, the processing module 618, the RCL module 700, the communication management unit 702, and/or the switch 704 may be embodied in a tangible and non-transitory computer readable storage medium having the instructions stored thereon.

Several OCUs 612 (e.g., “Operator Control Unit #1,” “Operator Control Unit #2,” and “Operator Control Unit #N”) are shown in FIG. 7. The OCUs 612 are generally referred to by the reference number 612 and individually referred to by the reference numbers 612a, 612b, and 612c. A plurality of OCUs 612 may concurrently or simultaneously wirelessly transmit control data 624 to one or more rail vehicle consists 602 (shown in FIG. 6) that are relatively close to one another. In a rail yard or other area where several rail vehicle consists 602 are located, several OCUs 612 may be transmitting different control data 624 intended to control operations of different rail vehicle consists 602. In order to prevent the incorrect control data 624 from being used to control operations of the incorrect rail vehicle consist, the data reading devices 616 of the rail vehicle consists may read or scan the identifying information from the OCUs 612 that are used to control the respective rail vehicle consists and then use the control data 624 transmitted by the corresponding OCUs 612 to control operations of the rail vehicle consists.

For example, a first OCU 612a may be transmitting control data 624 to control operations of a first rail vehicle consist while a second OCU 612b transmits control data 624 to control operations of a different, second rail vehicle consist. In order to prevent the control data 624 from the first OCU 612a from being used to control operations of the second rail vehicle consist and/or to prevent the control data 624 from the second OCU 612b from being used to control operations of the first rail vehicle consist, the data reading devices 616 on each of the first and second rail vehicle consists can identify the master OCU 612 that is used to control operations of the corresponding rail vehicle consist. For example, the data reading device 616 on the first rail vehicle consist may read or scan the identification data 706 from the first OCU 612a to identify the first OCU 612a as the master OCU 612 for the first rail vehicle consist. The data reading device 616 of the second rail vehicle consist may read or scan the identification data 706 from the second OCU 612b to identify the second OCU 612b as the master OCU 612 for the second rail vehicle consist. The first rail vehicle consist may receive and use the control data 624 transmitted by the first OCU 612a while ignoring or prohibiting the control data 624 from other, non-master OCUs 612 (including the second OCU 612b) from being used to control operations of the first rail vehicle consist. The second rail vehicle consist may receive and use the control data 624 transmitted by the second OCU 612b while ignoring or prohibiting the control data 624 from other, non-master OCUs 612 (including the first OCU 612a) from being used to control operations of the second rail vehicle consist. The determination of which OCU 612 is the master OCU 612 for a particular rail vehicle consist may be changed by scanning the identification data 706 of another OCU 612.

The data reading device 616 conveys the identification data received from the OCU 612 to the switch 704. The switch 704 conveys the identification data to the RCL module 700. For example, the switch 704 may include an Ethernet router, switch, or other component capable of directing the flow of data traffic within the processing module 618. The switch 704 directs the identification data from the data reading device 616 to the RCL module 700. The RCL module 700 receives the identification data and may identify a master OCU 612 based on the identification data. For example, the RCL module 700 may identify the OCU 612 associated with (e.g., identified by) the identification data as the master OCU 612. The identity of the master OCU 612 may be stored at the RCL module 700 or at another memory structure of the processing module 618.

The system 600 includes the transceiver 626 (e.g., “RCL Radio”) that receives the control data 624 from the associated master OCU 612 of the rail vehicle consist that includes the transceiver 626. The control data 624 may be transmitted from the OCU 612 along with a unique identifier, such as the identification data 706 or an identifier that is associated with the identification data 706 or otherwise distinguishes the OCU 612 from one or more other OCUs 612. The transceiver 626 receives the control data 624 and the identifier of the OCU 612 that transmitted the control data 624. The transceiver 626 conveys the received control data 624 and the identifier of the OCU 612 to the RCL module 700. The RCL module 700 examines the control data 624 and the identifier associated with the control data 624 to determine if the control data 624 is transmitted from the master OCU 612 of the rail vehicle consist that includes the system 600 or from another OCU 612. The RCL module 700 can compare the identifier received with the control data 624 with the identity of the master OCU 612 that is stored at the RCL module 700 or at another location within the processing module 618. If the identifier matches the identity of the master OCU 612, then the RCL module 700 may determine that the associated control data 624 is transmitted from the master OCU 612. As a result, the RCL module 700 conveys the corresponding control data 624 to the communication management unit 702 via the switch 704. On the other hand, if the identifier does not match the identity of the master OCU 612, then the RCL module 700 may determine that the associated control data 624 is not transmitted from the master OCU 612. As a result, the RCL module 700 prohibits the corresponding control data 624 from being transmitted to the communication management unit 702. For example, the RCL module 700 may disregard or otherwise ignore the control data 624.

The communication management unit 702 receives the control data 624 transmitted by the master OCU 612 and determines which operations of the rail vehicle consist that includes the system 600 are to be changed or maintained by the control data 624. For example, the communication management unit 702 may determine if the tractive effort and/or braking effort provided by one or more of the powered units 604, 606 (shown in FIG. 6) needs to be changed in order to comply with the control data 624. If the control data 624 directs the speed of the rail vehicle consist to be decreased, the communication management unit 702 may determine that a throttle setting of one or more of the powered units 604, 606 needs to be reduced and/or one or more brakes of the powered units 604, 606 need to be applied. The communication management unit 702 forms instructions to the propulsion subsystems 614 based on the control data 624, such as instructions that direct a change in throttle and/or brake settings, and communicates the instructions to the propulsion subsystems 614. For example, the communication management unit 702 may transmit instructions to the propulsion subsystem 614 in the same powered unit 604 or 606 as the communication management unit 702 and/or to the propulsion subsystem 614 of one or more other powered units 604, 606 of the same rail vehicle consist. In one embodiment, the communication management unit 702 communicates the instructions through the network connection 610. The powered units 604, 606 that receive the instructions modify the operations of the powered units 604, 606 in response to the received instructions. For example, the powered units 604, 606 may change throttle settings and/or brake settings to alter tractive effort and/or braking effort.

In the illustrated embodiment, the system 600 includes a display 708 that visually presents information to an operator of the rail vehicle consist. For example, the display 708 may present information related to or representative of control data 624, identification data 706, throttle settings, brake settings, and the like, to the operator.

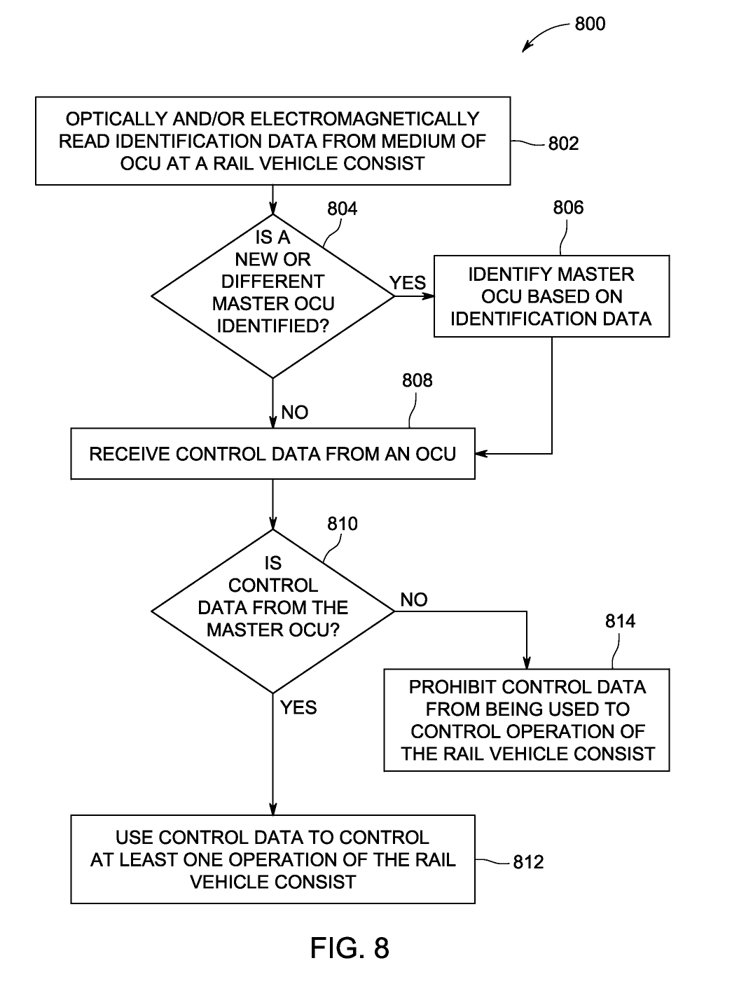

FIG. 8 is a flowchart of another embodiment of a method 800 for communicating data with a rail vehicle consist. The method 800 may be used in conjunction with one or more embodiments of the communication system 600 (shown in FIG. 6) described herein.

At 802, identification data is read from a tangible and non-transitory medium of an OCU at a rail vehicle consist. For example, the OCU 612 (shown in FIG. 6) that is capable of remotely controlling operations (e.g., tractive and/or braking operations) of the rail vehicle consist 602 (shown in FIG. 6) using wirelessly transmitted control data 624 (shown in FIG. 6) may include a visually presented image (e.g., a bar code, image, or text) that represents identification data of the OCU 612 and/or an RFID tag having the identification data encoded therein. The image can be printed onto the housing of the OCU 612 and/or electronically displayed on a display screen of the OCU 612. The RFID tag can be coupled to the OCU 612. The identification data can be optically and/or electromagnetically read from the OCU 612. For example, an optical scanner can be used to read the identification data from an image printed on the OCU 612 and/or an RF interrogator may interrogate an RFID tag of the OCU 612 to read the identification data, as described above.

At 804, a determination is made as to whether the identification data represents a new or different OCU. The identification data may be new if there currently is no master OCU 612 (shown in FIG. 6) associated with the rail vehicle consist. For example, the rail vehicle consist may not currently be under the remote control of another OCU 612. In another example, the rail vehicle consist may be capable of being remotely controlled by a predetermined number “N” of master OCUs 612 (e.g., primary, secondary, tertiary, and the like, master OCUs 612), but currently is under the remote control of a number of master OCUs 612 that is less than the number N of master OCUs 612 that the rail vehicle consist can be controlled by. The recently acquired identification data represents a new or an additional master OCU 612 that is allowed to remotely control operations of the rail vehicle consist.

The identification data may be different if the recently read identification data differs from the identification data of a current master OCU 612 (shown in FIG. 6). For example, if the rail vehicle consist is currently under the control of a master OCU 612 and/or under the control of the predetermined number N of master OCUs 612, and the recently acquired identification data differs from the identification data of the current master OCU 612 or master OCUs 612, then the recently acquired identification data is different identification data.

If the recently acquired identification data is different or new, then the identification data can indicate that the new OCU 612 (shown in FIG. 6) identified by the identification data is a master OCU 612 for the rail vehicle consist. As a result, flow of the method 800 flows to 806. On the other hand, if the recently acquired identification data is not different or new, such as by being the same identification data as an existing OCU 612 or identification data that does not represent an OCU 612 (e.g., no OCU is identified by the identification data), then the identification data may not indicate that the OCU 612 identified by the identification data is a new or different master OCU 612 of the rail vehicle consist. As a result, flow of the method 800 proceeds to 808 and the rail vehicle consist may remain under the control of a previously identified master OCU 612 and/or may prohibit the OCU 612 from remotely controlling operations of the rail vehicle consist.

At 806, the OCU associated with the identification data acquired at 802 is identified as a master OCU for the rail vehicle consist. For example, the identified OCU 612 (shown in FIG. 6) may be a master OCU 612 for the rail vehicle consist such that the master OCU 612 can remotely control operations of the rail vehicle consist.

At 808, control data is received from one or more OCUs. The control data may be received at the rail vehicle consist from a plurality of OCUs, including one or more OCUs that are not master OCUs for the rail vehicle consist. For example, in an area that is relatively congested with many rail vehicle consists and OCUs, the rail vehicle consist may receive control data that is intended for another rail vehicle consist and/or control data that is intended for the rail vehicle consist.

At 810, a determination is made as to whether the control data received by the rail vehicle consist is from the master OCU of the rail vehicle consist. For example, the control data may be transmitted from the OCUs 612 (shown in FIG. 6) along with identifiers of the OCUs 612 that transmit the control data. The rail vehicle consist can receive the control data and the identifiers of the OCUs 612 that transmitted the control data. The received identifiers can be compared to the stored identification data or other identifier of the master OCU 612 of the rail vehicle consist. If the identifier that is received with the control data matches the identification data or identifier of the master OCU 612 (e.g., the identifier received with the control data is the same or has at least a predetermined number of similarities with the identification data or identifier of the master OCU 612), then the control data is likely transmitted from the master OCU 612. As a result, flow of the method 800 flows to 812.

On the other hand, if the identifier that is received with the control data does not match the identification data or identifier of the master OCU 612 (shown in FIG. 6), then the control data is likely transmitted from an OCU 612 other than the master OCU 612 of the rail vehicle consist. As a result, flow of the method 800 flows to 814.

At 812, the control data from the master OCU is used to control one or more operations of the rail vehicle consist. For example, the control data may be used by a powered unit of the rail vehicle consist to form instructions or directions that are communicated to one or more propulsion subsystems on the rail vehicle consist and used to modify tractive effort and/or braking effort provided by the propulsion subsystems, as described above. Also as described above, more than one master OCU may be associated with a single rail vehicle consist and/or a single powered unit of a rail vehicle consist. The different master OCUs may have different control data that each master OCU is permitted to use to control the same rail vehicle consist and/or powered unit. For example, a primary master OCU may have control over throttle and/or brake settings, while a secondary master OCU may have control over operations other than tractive and/or braking efforts.

At 814, the control data from the non-master OCU is prohibited from being used to control operations of the rail vehicle consist. For example, the control data that is received from an OCU other than the master OCU of the rail vehicle consist may be disregarded or otherwise ignored and not acted on to change tractive efforts and/or braking efforts of the rail vehicle consist.

Flow of the method 800 may return to one or more operations described above. For example, the method 800 may return to 808 to receive additional control data from one or more OCUs. As another example, the method 800 may return to 802 to receive identification data of a new or different master OCU.

One or more embodiments described herein provide for systems and methods for communicating data with a rail vehicle consist. The data may be transmitted in a more reliable manner than heretofore used, such as by containing the data in a bar code or other image, human-readable text, an RFID tag or label, and the like, and scanning or reading the data from the bar code, image, text, RFID tag or label. Communicating the data in this manner may be more reliable and/or faster than some known methods of communicating the data.

In one embodiment, a data communication system for a rail vehicle consist is provided. The system includes a data reading device and a processing module. The data reading device is disposed on the rail vehicle consist and is configured to at least one of electromagnetically interrogate or optically read identification data that is visually presented on a first operator control unit. The first operator control unit is configured to remotely control operations of one or more powered units of the rail vehicle consist when the operator control unit is disposed outside of the one or more powered units. The processing module is disposed on the rail vehicle consist and is communicatively coupled with the data reading device. The processing module receives the identification data from the data reading device and uses the identification data to identify the first operator control unit and allow the first operator control unit to remotely control operations of the one or more powered units.

In another aspect, the first operator control unit is one of plural operator control units that are configured to remotely control operations of the rail vehicle consist, and the processing module is configured to prohibit one or more of the operator control units other than the first operator control unit from remotely controlling operations of the rail vehicle consist based on the identification data.

In another aspect, the data reading device is an optical scanning device configured to optically scan the identification data that is visually presented on the first operator control unit.

In another aspect, the identification data is visually presented on the first operator control unit as optical machine-readable data.

In another aspect, the identification data is presented as at least one of a bar code, an image, or text that is visually presented on the first operator control unit.

In another aspect, the identification data is visually presented on at least one of a document or a display device that is included in or coupled with the first operator control unit, and the identification data is at least one of printed on the document or electronically displayed on the display device.

In another aspect, the system also includes a radio frequency identification (RFID) tag coupled with the first operator control unit, the RFID tag having the identification data encoded in the RFID tag. The data reading device includes an RFID interrogator device configured to read the identification data from the RFID tag using electromagnetic waves of an interrogation field emitted by the RFID interrogator device.

In another aspect, the processing module is communicatively coupled to at least one propulsion subsystem of the rail vehicle consist and is configured to receive control data wirelessly transmitted from the first operator control unit to control at least one of tractive effort or braking effort provided by the propulsion subsystem based on the control data received from the first operator unit.

In another aspect, the operator control units are handheld control units, such as electronic devices that may be carried by one or two hands of a human operator of average size and strength without assistance from another human being and/or other mechanical devices.

In another embodiment, a method for communicating data with a rail vehicle consist is provided. The method includes, on a rail vehicle of the rail vehicle consist, at least one of interrogating or reading identification data that is visually presented on a first operator control unit using a data reading device. The first operator control unit is configured to remotely control operations of one or more powered units of the rail vehicle consist when the operator control unit is disposed outside of the one or more powered units. The method also includes identifying the first operator control unit as a linked operator control unit based on the identification data that is read from the first operator control unit and receiving control data from the linked operator control unit to change at least one operation of the one or more powered units.

In another aspect, the first operator control unit is one of plural operator control units that are configured to remotely control operations of one or more powered units of the rail vehicle consist when the operator control unit is disposed outside of the one or more powered units. The method may also include prohibiting the control data received from one or more of the operator control units other than the linked operator control unit from changing the at least one operation of the one or more powered units.

In another aspect, the at least one of interrogating and reading step includes optically scanning the identification data that is visually presented on the first operator control unit.

In another aspect, the method also includes printing the identification data on the first operator control unit.

In another aspect, the at least one of interrogating and reading step includes reading the identification data from at least one of a bar code, an image, or text that is printed on the first operator control unit.

In another aspect, the identification data is visually presented on at least one of a document or a display device that is included in or coupled with the first operator control unit, and the identification data is at least one of printed on the document or electronically displayed on the display device.

In another aspect, the identification data is encoded in a radio frequency identification (RFID) tag that is coupled with the first operator control device, and the interrogating and reading step includes interrogating the RFID tag with an interrogation field of electromagnetic waves emitted by an RFID interrogator device.

In another aspect, the receiving step includes processing the control data to control at least one of tractive effort or braking effort provided by the one or more powered units.

In another embodiment, a computer readable storage medium is provided. The computer readable storage medium includes one or more sets of instructions that direct a data reading device on a powered unit of a rail vehicle consist to at least one of interrogate or optically read identification data that is visually presented on a first operator control unit. The first operator control unit is configured to remotely control operations of one or more powered units of the rail vehicle consist when the operator control unit is disposed outside of the one or more powered units. The one or more sets of instructions also direct a processor on board the consist to identify the first operator control unit based on the identification data, and receive control data transmitted from the first operator control unit that is used to control at least one operation of one or more of the powered units.

In another aspect, the computer readable storage medium is a tangible and non-transitory medium.

In another aspect, the first operator control unit is one of plural operator control units that are configured to remotely control operations of one or more powered units of the rail vehicle consist when the operator control unit is disposed outside of the one or more powered units, and the one or more sets of instructions direct the processor to prohibit control data transmitted from one or more operator control units other than the first operator control unit from controlling the at least one operation of the one or more powered units based on the identification data.

In another aspect, the identification data is visually presented on the first operator control unit as optical machine-readable data.

In another aspect, the identification data is presented as at least one of a bar code, an image, or text that is visually presented on the first operator control unit.

In another aspect, the identification data is encoded in a radio frequency identification (RFID) tag coupled with the first operator control unit, and wherein the one or more sets of instructions direct the data reading device to read the identification data from the RFID tag using electromagnetic waves of an interrogation field emitted by an RFID interrogator device.

In another aspect, the one or more sets of instructions direct the processor to control at least one of tractive effort or braking effort provided by a propulsion subsystem of one or more of the powered units of the rail vehicle consist based on the control data received from the first operator unit.

In another embodiment, a data communication system for a rail vehicle is provided. The system includes a human-portable operator control unit having an electronic display, an operator interface, a transceiver, and a control module. The display, the operator interface, and the transceiver are operably coupled to the control module. The operator interface is configured to receive operator input from a human operator. The control module is configured to generate control data based on the operator input. The transceiver is configured to transmit the control data to the rail vehicle for remotely controlling the rail vehicle. The control module is configured to control the display for visually presenting identification data of the operator control unit. The identification data is configured for at least one of electromagnetic interrogation or optical reading off of the display by a data reading device spaced apart from the operator control unit.

In another aspect, the control module is configured to control the display for visually presenting the identification data as at least one of a bar code, an image, or text.

In another aspect, the control module is configured to transmit the control data to the rail vehicle for remotely controlling the rail vehicle only after the identification data is optically read from the display by the data reading device.

In another embodiment, a computer readable storage medium comprising one or more sets of instructions is provided. The computer readable storage medium includes one or more sets of instructions are readable by a control module of a human-portable operator control unit for remotely controlling a rail vehicle. The one or more sets of instructions are configured, when executed by the control module, to cause the control module to control a display of the operator control unit for visually presenting identification data of the operator control unit, the identification data being configured for at least one of electromagnetic interrogation or optical reading off the display by a data reading device spaced apart from the operator control unit.

In another aspect, the computer readable storage medium is a tangible and non-transitory medium.

In another aspect, the one or more sets of instructions are configured, when executed by the control module, to cause the control module to control the display to visually present at least one of a bar code, an image, or text as the identification data.

In another embodiment, a data communication system for a rail vehicle is provided. The system includes a processing module configured to interface with a propulsion subsystem of a rail vehicle and with a data reading device configured to at least one of electromagnetically interrogate or optically read identification data that is visually presented on a first operator control unit. The processing module is configured to receive identification data from the data reading device and to use the identification data to identify the first operator control unit and allow the first operator control unit to remotely control operations of the rail vehicle.

In another aspect, the processing module is further configured to prohibit one or more of plural operator control units other than the first operator control unit from remotely controlling operations of the rail vehicle based on the identification data.

In another embodiment, a data communication system for a rail vehicle is provided. The system includes a data reading device comprising a base for at least one of mechanically or electrically installing the data reading device on a rail vehicle. The data reading device also includes a reader unit attached to the base and configured to at least one of electromagnetically interrogate or optically read identification data that is visually presented on a first operator control unit. The system also includes a processing module configured to interface with the data reading device and with a control system of the rail vehicle, the processing module configured to receive identification data from the data reading device and to use the identification data to identify the first operator control unit and allow the first operator control unit to remotely control operations of the rail vehicle.

In another aspect, the processing module is further configured to prohibit one or more of plural operator control units other than the first operator control unit from remotely controlling operations of the rail vehicle based on the identification data.

In another embodiment, another data communication system for a rail vehicle consist is provided. The system includes an optical scanning device and a processing module. The optical scanning device is disposed on the rail vehicle consist and is configured to interrogate and read data from a handheld operator control unit that is spaced apart from the optical scanning device and located on-board the rail vehicle consist. The data is visually presented on the operator control unit as at least one of a bar code, an image, or text. The processing module is disposed on the rail vehicle consist and is communicatively coupled with the optical scanning device. The processing module is configured to receive the data from the optical scanning device and to use the data, or to communicate the data to another part of the rail vehicle consist that uses the data, for receiving control data from the operator control unit to control at least one of tractive effort or braking effort provided by one or more powered units of the rail vehicle consist while prohibiting other control data received from other operator control units from controlling the at least one of tractive effort or braking effort.

In another embodiment, another data communication system for a rail vehicle consist is provided. The system includes a radio frequency (RF) interrogator and a processing module. The RF interrogator is disposed on the rail vehicle consist and is configured to interrogate a radio frequency identification (RFID) tag coupled with a handheld operator control unit with electromagnetic waves and read data encoded in the RFID tag. The RF interrogator reads the data from the RFID tag when the RFID tag is spaced apart from the RF interrogator and located on-board the rail vehicle consist. The processing module is disposed on the rail vehicle consist and is communicatively coupled with the RF interrogator. The processing module is configured to receive the data from the RF interrogator and to use the data, or to communicate the data to another part of the rail vehicle consist that uses the data, for receiving control data from the operator control unit to control at least one of tractive effort or braking effort provided by one or more powered units of the rail vehicle consist while prohibiting other control data received from other operator control units from controlling the at least one of tractive effort or braking effort.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to one of ordinary skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments disclosed herein, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the disclosed subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods for communicating with a rail vehicle, without departing from the spirit and scope of the subject matter herein involved, it is intended that all of the subject matter of the above description or shown in the accompanying drawings shall be interpreted merely as examples illustrating the inventive concepts herein and shall not be construed as limiting the disclosed subject matter.

What is claimed is:

1. A data communication system for a rail vehicle consist, the system comprising:
a data reading device disposed on the rail vehicle consist, the data reading device configured to at least one of electromagnetically interrogate or optically read identification data that is visually presented on a first operator control unit, wherein the first operator control unit is configured to remotely control operations of one or more powered units of the rail vehicle consist when the operator control unit is disposed outside of the one or more powered units; and
a processing module disposed on the rail vehicle consist and communicatively coupled with the data reading device, the processing module receiving the identification data from the data reading device and using the identification data to identify the first operator control unit and allow the first operator control unit to remotely control operations of the one or more powered units.

2. The system of claim 1, wherein the first operator control unit is one of plural operator control units that are configured to remotely control operations of the rail vehicle consist, and wherein the processing module is configured to prohibit one or more of the operator control units other than the first operator control unit from remotely controlling operations of the rail vehicle consist based on the identification data.

3. The system of claim 1, wherein the data reading device is an optical scanning device configured to optically scan the identification data that is visually presented on the first operator control unit.

4. The system of claim 1, wherein the identification data is visually presented on the first operator control unit as optical machine-readable data.

5. The system of claim 1, wherein the identification data is presented as at least one of a bar code, an image, or text that is visually presented on the first operator control unit.

6. The system of claim 1, wherein the identification data is visually presented on at least one of a document or a display device that is included in or coupled with the first operator control unit, and the identification data is at least one of printed on the document or electronically displayed on the display device.

7. The system of claim 1, further comprising a radio frequency identification (RFID) tag coupled with the first operator control unit, the RFID tag having the identification data encoded in the RFID tag, wherein the data reading device includes an RFID interrogator device configured to read the identification data from the RFID tag using electromagnetic waves of an interrogation field emitted by the RFID interrogator device.

8. The system of claim 1, wherein the processing module is communicatively coupled to at least one propulsion subsystem of the rail vehicle consist and is configured to receive control data wirelessly transmitted from the first operator control unit to control at least one of tractive effort or braking effort provided by the propulsion subsystem based on the control data received from the first operator unit.

9. A method for communicating data with a rail vehicle consist, the method comprising, on a rail vehicle of the rail vehicle consist:
at least one of interrogating or reading identification data that is visually presented on a first operator control unit using a data reading device, wherein the first operator control unit is configured to remotely control operations of one or more powered units of the rail vehicle consist when the operator control unit is disposed outside of the one or more powered units;
identifying the first operator control unit as a linked operator control unit based on the identification data that is read from the first operator control unit; and
receiving control data from the linked operator control unit to change at least one operation of the one or more powered units.

10. The method of claim 9, wherein:
the first operator control unit is one of plural operator control units that are configured to remotely control operations of one or more powered units of the rail vehicle consist when the operator control unit is disposed outside of the one or more powered units; and
the method further comprises prohibiting the control data received from one or more of the operator control units other than the linked operator control unit from changing the at least one operation of the one or more powered units.

11. The method of claim 9, wherein the at least one of interrogating and reading step includes optically scanning the identification data that is visually presented on the first operator control unit.

12. The method of claim 9, further comprising printing the identification data on the first operator control unit.

13. The method of claim 9, wherein the at least one of interrogating and reading step includes reading the identification data from at least one of a bar code, an image, or text that is printed on the first operator control unit.

14. The method of claim 9, wherein the identification data is visually presented on at least one of a document or a display device that is included in or coupled with the first operator control unit, and the identification data is at least one of printed on the document or electronically displayed on the display device.

15. The method of claim 9, wherein the identification data is encoded in a radio frequency identification (RFID) tag that is coupled with the first operator control device, and the interrogating and reading step includes interrogating the RFID tag with an interrogation field of electromagnetic waves emitted by an RFID interrogator device.

16. The method of claim 9, wherein the receiving step includes processing the control data to control at least one of tractive effort or braking effort provided by the one or more powered units.

17. A computer readable storage medium including one or more sets of instructions that:
direct a data reading device on a powered unit of a rail vehicle consist to at least one of interrogate or optically read identification data that is visually presented on a first operator control unit, wherein the first operator control unit is configured to remotely control operations of one or more powered units of the rail vehicle consist when the operator control unit is disposed outside of the one or more powered units; and
direct a processor on board the consist to identify the first operator control unit based on the identification data, and receive control data transmitted from the first operator control unit that is used to control at least one operation of one or more of the powered units.

18. The computer readable storage medium of claim 17, wherein the first operator control unit is one of plural operator control units that are configured to remotely control operations of one or more powered units of the rail vehicle consist when the operator control unit is disposed outside of the one or more powered units, and the one or more sets of instructions direct the processor to prohibit control data transmitted from one or more operator control units other than the first operator control unit from controlling the at least one operation of the one or more powered units based on the identification data.

19. The computer readable storage medium of claim 17, wherein the identification data is visually presented on the first operator control unit as optical machine-readable data.

20. The computer readable storage medium of claim 17, wherein the identification data is presented as at least one of a bar code, an image, or text that is visually presented on the first operator control unit.

21. The computer readable storage medium of claim 17, wherein the identification data is encoded in a radio frequency identification (RFID) tag coupled with the first operator control unit, and wherein the one or more sets of instructions direct the data reading device to read the identification data from the RFID tag using electromagnetic waves of an interrogation field emitted by an RFID interrogator device.

22. The computer readable storage medium of claim 17, wherein the one or more sets of instructions direct the processor to control at least one of tractive effort or braking effort provided by a propulsion subsystem of one or more of the powered units of the rail vehicle consist based on the control data received from the first operator unit.

23. A data communication system for a rail vehicle, the system comprising:
a human-portable operator control unit having an electronic display, an operator interface, a transceiver, and a control module, wherein the display, the operator interface, and the transceiver are operably coupled to the control module;
wherein the operator interface is configured to receive operator input from a human operator, the control module is configured to generate control data based on the operator input, and the transceiver is configured to transmit the control data to the rail vehicle for remotely controlling the rail vehicle; and
wherein the control module is configured to control the display for visually presenting identification data of the operator control unit, the identification data being configured for at least one of electromagnetic interrogation or optical reading off of the display by a data reading device spaced apart from the operator control unit.

24. The system of claim 23, wherein the control module is configured to control the display for visually presenting the identification data as at least one of a bar code, an image, or text.

25. The system of claim 23, wherein the control module is configured to transmit the control data to the rail vehicle for remotely controlling the rail vehicle only after the identification data is optically read from the display by the data reading device.

26. A computer readable storage medium comprising one or more sets of instructions, wherein:
the one or more sets of instructions are readable by a control module of a human-portable operator control unit for remotely controlling a rail vehicle; and
the one or more sets of instructions are configured, when executed by the control module, to cause the control module to control a display of the operator control unit for visually presenting identification data of the operator control unit, the identification data being configured for at least one of electromagnetic interrogation or optical reading off the display by a data reading device spaced apart from the operator control unit.

27. The computer readable storage medium of claim 26, wherein the one or more sets of instructions are configured, when executed by the control module, to cause the control module to control the display to visually present at least one of a bar code, an image, or text as the identification data.

28. A data communication system for a rail vehicle, the system comprising:
a processing module configured to interface with a propulsion subsystem of a rail vehicle and with a data reading device configured to at least one of electromagnetically interrogate or optically read identification data that is visually presented on a first operator control unit, the processing module configured to receive identification data from the data reading device and to use the identification data to identify the first operator control unit and allow the first operator control unit to remotely control operations of the rail vehicle.

29. The system of claim 28, wherein the processing module is further configured to prohibit one or more of plural operator control units other than the first operator control unit from remotely controlling operations of the rail vehicle based on the identification data.

30. A data communication system for a rail vehicle, the system comprising:
a data reading device comprising a base for at least one of mechanically or electrically installing the data reading device on a rail vehicle, and further comprising a reader unit attached to the base and configured to at least one of electromagnetically interrogate or optically read identification data that is visually presented on a first operator control unit; and
a processing module configured to interface with the data reading device and with a control system of the rail vehicle, the processing module configured to receive identification data from the data reading device and to use the identification data to identify the first operator control unit and allow the first operator control unit to remotely control operations of the rail vehicle.

31. The system of claim 30, wherein the processing module is further configured to prohibit one or more of plural operator control units other than the first operator control unit from remotely controlling operations of the rail vehicle based on the identification data.
